(19) United States
(12) Patent Application Publication
(10) Pub. No.: US 2016/0126578 A1
(43) Pub. Date: May 5, 2016

(54) CONSOLIDATED FUEL CELL ELECTRODE

(71) Applicant: Nuvera Fuel Cells, Inc., Billerica, MA (US)

(72) Inventors: Scott Blanchet, Chelmsford, MA (US); James Cross, III, Lowell, MA (US); Ales Horky, North Vancouver (CA); Atul Sharma, Belmont, MA (US); Filippo Gambini, Boston, MA (US); Gabriel Corbellini, Somerville, MA (US); Benjamin Lunt, Tewksbury, MA (US)

(73) Assignee: NUVERA FUEL CELLS, INC., Billerica, MA (US)

(21) Appl. No.: 14/935,734

(22) Filed: Nov. 9, 2015

Related U.S. Application Data
(63) Continuation of application No. 12/489,406, filed on Jun. 22, 2009, now abandoned.
(60) Provisional application No. 61/074,814, filed on Jun. 23, 2008.

(51) Int. Cl. H01M 8/1004; H01M 8/1018; H01M 4/96

(52) U.S. Cl. CPC H01M 8/1004; H01M 4/96; H01M 8/1018; H01M 2008/1095

(57) ABSTRACT

This disclosure related to polymer electrolyte member fuel cells and components thereof, including fuel cell electrodes.

### CROSS REFERENCES TO RELATED APPLICATION

This application is a continuation application of U.S. patent application Ser. No. 12/489,406, filed Jun. 22, 2009, which claims the benefit of U.S. Provisional Application No. 61/074,814, filed Jun. 23, 2008, both of which are incorporated herein by reference.

### TECHNICAL FIELD

The present disclosure is directed to the field of polymer electrolyte membrane fuel cells and fuel cell electrodes.

### BACKGROUND

A typical polymer electrolyte membrane (PEM) fuel cell (also known as a Proton Exchange Membrane fuel cell) has several components. It has a polymer membrane serving as an electrolyte, which provides the function of protonic conductivity when sufficiently hydrated, as well as segregation of the highly reactive gases, i.e., hydrogen and oxygen. Catalysts are used to promote the electrochemical reactions that enable the cell to produce power—specifically to dissociate the hydrogen on the anode side into its constituent electrons and protons, and to form activated oxygen-containing species on the cathode side.

The anode electrode catalyst and the cathode electrode catalyst are typically applied to their respective sides of the cell in one of two ways: (1) in the form of a gas diffusion electrode (GDE), wherein the catalyst and its support are impregnated onto a gas diffusion media (typically a matte of pyrolized carbon or graphite fibers) placed between the reactant flowfield and the membrane; or (2) in the form of a catalytically coated membrane (CCM), wherein the catalyst and its support are fixed onto an ionomeric extension of the polymer membrane surface on their respective sides. Regardless of which form is used, during assembly of the cell an electrical connection is established between the gas diffusion media and the polymer membrane, with the catalyst located in between. The side of the membrane that is in contact with an anode catalyst is the anode side, while the side of the membrane that is in contact with a cathode catalyst is the cathode side.

A fuel cell also has two separator plates (also known as “bipolar plates”), which serve to conduct electricity while segregating adjacent fluidic compartments. An anode compartment is the space that is between the anode side of the membrane and a separator plate. A cathode compartment is the space that is between the cathode side of the membrane and the separator plate.

A fuel gas, e.g., a hydrogen-containing gas, is fed to the anode compartment. An oxidant-containing gas, e.g., air, is fed to the cathode compartment. For the fuel cell to work, hydrogen must be able to reach the anode side of the membrane while oxygen must reach the cathode side. Electrically conductive spacers are used to create passages in the anode compartment and the cathode compartment respectively. These spacers also serve as the flowfields through which reactant gases and product water are convected. As used herein, the terms “flowfield” and “flowfield spacer” and “spacer,” all of which refer to a component with multiple functions, are used interchangeably in this disclosure.

### SUMMARY

This disclosure provides a fuel cell, which comprises a flowfield having a first surface and a second surface, a polymer membrane, and an electrode catalyst. The first surface of the flowfield is adjacent to the polymer membrane and the electrode catalyst is interposed between the first surface of the flowfield and the polymer membrane.

In certain embodiments the flowfield is a porous metal foam or a corrugated metal sheet with perforations. Furthermore, the electrode catalyst may be deposited on the flowfield. In certain embodiments, the fuel cell further comprises an intermediate structure interposed between the flowfield and the polymer membrane and the electrode catalyst is deposited on the intermediate structure.

In some embodiments, the intermediate structure can be a carbon-based catalyst support layer. In other embodiments the intermediate structure is chosen from a metal wire mesh, a wire mesh comprising metal wires and a non-metal component, a metal screen, and an expanded metal sheet. The non-metal component may be electrically conductive, such as carbon fiber.

The disclosure further provides a fuel cell electrode, which comprises a porous structure chosen from a porous metal foam, a metal wire mesh, a wire mesh comprising metal wires and a non-metal component, a metal screen, a metal felt, an expanded metal sheet, a corrugated metal sheet with perforations, and a corrugated metal sheet without perforations. The fuel cell electrode further comprises an electrode catalyst deposited on the porous structure.

In certain embodiments, the electrode comprises a carbon-based catalyst support wherein the electrode catalyst is affixed to the catalyst support. The catalyst support may comprise carbon filaments.

### DESCRIPTION OF DRAWINGS

FIGS. 1A, 1B, and 1C show some embodiments of electrodes comprising porous flowfields.

FIG. 2 show another embodiment of electrode according to this disclosure.

FIG. 3 shows a further embodiment of electrode according to this disclosure.

FIGS. 4, 5, 6, 7, and 8 illustrate embodiments of electrodes having perforated corrugated metal sheets.

FIGS. 9A, 9B, and 9C show embodiments of an intermediate structure according to this disclosure.

### DETAILED DESCRIPTIONS

A plate (typically graphite or metal) containing discrete flow channels is one of the commonly used flowfields. However, since the directed flow is limited within the flow channels in these plates, and the contact area between the plate with the anode or cathode of the fuel cell masks catalytically active regions, these types of flowfields suffer from mass transfer limitations and generally cannot operate at high power density, i.e., above 1 Watt/cm². In contrast, high porosity open structure materials, such as metal foam, metal mesh, metal screen, corrugated plates that include perforations, or laminates composed of such elements, etc., do not have well defined flow passages. These porous spacers are also referred to as open flowfields.

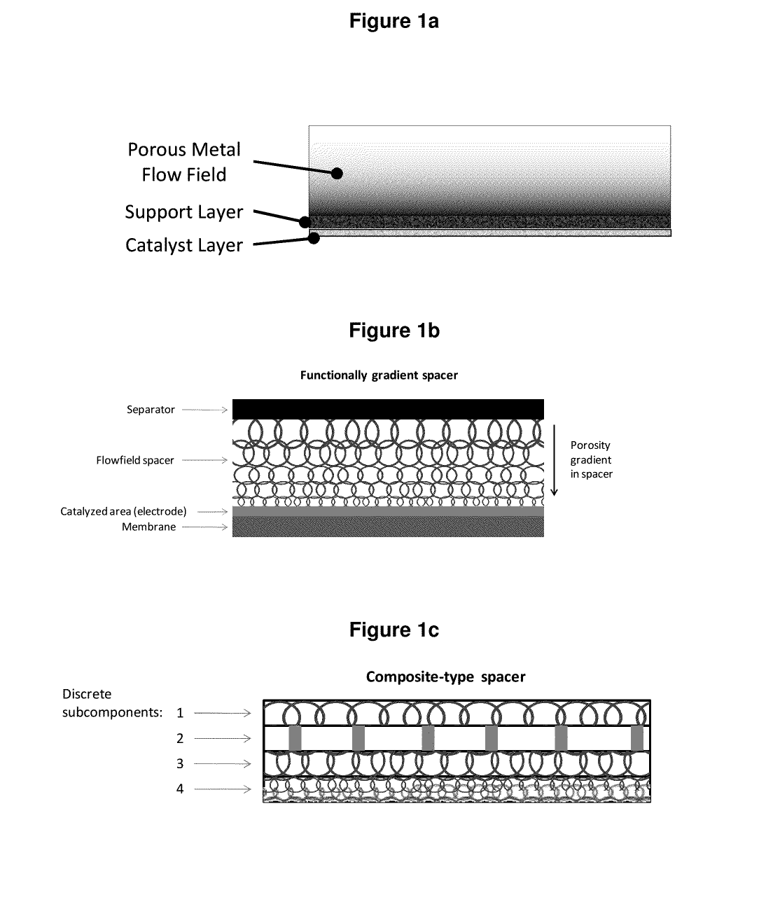

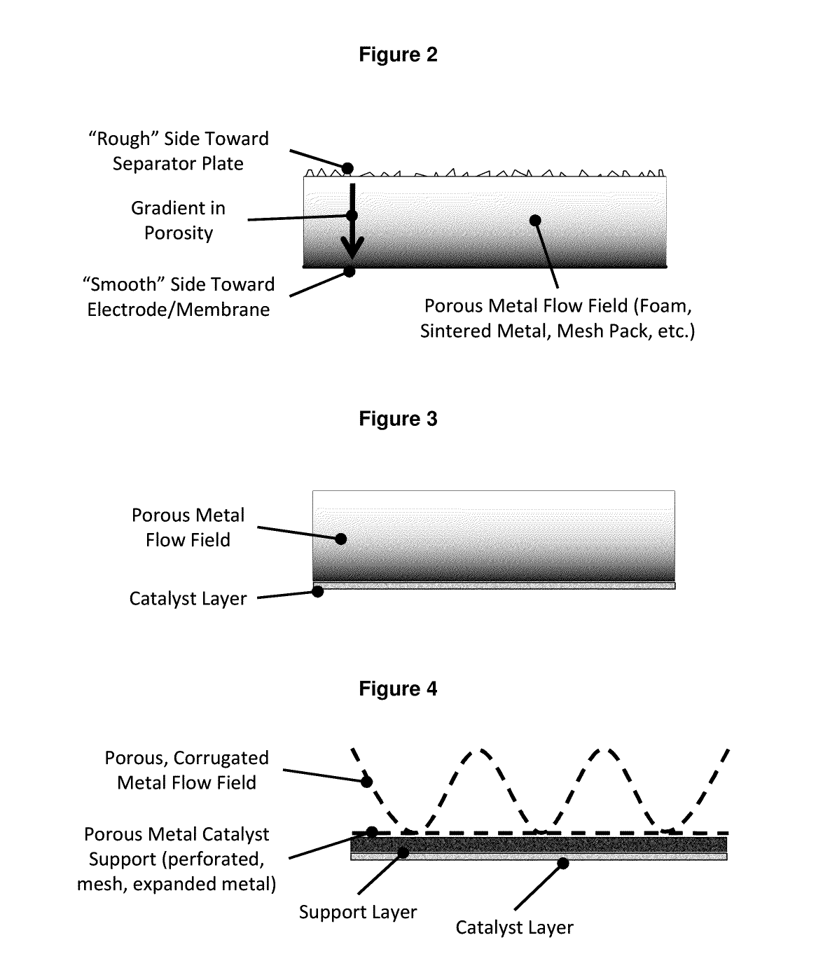

This disclosure describes a fuel cell in which either (1) the anode, (2) the cathode, or (3) both, comprises the catalyst, and optionally its support, applied directly to a metallic flowfield spacer. FIGS. 1 and 2, for example, illustrate embodiments of open flowfields according to this disclosure.

FIG. 1A shows an open flowfield that comprises corrosion-resistant porous metal flow field, a catalyst support layer, and a catalyst layer deposited on the catalyst support layer. The porous metal flowfield may be metal foam, metal screen, or metal mesh or felt.

The metal foam has a reticulated structure with an interconnected network of ligaments. Because of this unique structure, the foam material in an uncompressed state can have a porosity that reaches at 75%, such as greater than 80%, greater than 85%, greater than 90%, greater than 95%, and up to 98%. An example of metal foams that are commercially available is can be obtained from Porvair Advanced Materials, Inc.

Another suitable flowfield is an expanded metal mesh. An expanded metal mesh is made from sheets of solid metal that are uniformly slit and stretched to create openings of certain geometric shapes, e.g., a diamond shape. In a standard expanded metal, each row of diamond-shaped openings is offset from the next, creating an uneven structure. The standard expanded metal sheet can be rolled to produce a flattened expanded metal.

A metal wire mesh can also be used as an open flowfield. It can be made by weaving or welding metal wires together. Both metal wire mesh and expanded metal mesh are commercially available, for example, from Mechanical Metals, Inc. of Newtown, Pa. When used as a spacer, the expanded metal mesh and the metal wire mesh may first be processed to form a non-flat geometric shape.

The flowfield can have a uniform pore size distribution and/or void fraction or the flowfield can have a spatially varying (e.g. functionally gradient or discontinuous) pore size distribution and/or void fraction. In the embodiment according to FIG. 2, the flowfield has a porosity gradient in the direction perpendicular to the planar direction of the flowfield. In this embodiment, the porosity near the polymer membrane is lower than the porosity near the separator.

The flowfields conceived herein may have a regular or an irregular lattice structure. A regular lattice structure contains identical repeating units cells. Its pore size and void fraction are all well-defined. For an irregular structure, its pore size and void fraction is based on a statistically significant number of pores or control volume size. In certain embodiments of this disclosure, the size of flowfield pores can be less than 1 mm and the void fraction can be at least 75%, for example, greater than 80%, greater than 85%, greater than 90%, and up to 98% in the bulk of the flowfield away from the membrane.

In certain embodiments, void fractions of less than 75% may lead to high flow resistances, which adversely impact system efficiency and reduce power density. In certain embodiments, when the void fraction is higher than 98%, the flowfield may not have enough material for effective heat transfer and electronic conduction. In the region contacting or adjacent to the electrode, the pore size and void fractions can be equal to or smaller than those away from the membrane.

The pore structure of the flowfield can be created by one or more of the following methods: initial processing methods, post-production after-treatments, or layering and/or bonding of discrete subcomponents having either uniform or variable porosity, herein meaning pore size distribution and/or void fraction into a composite structure (see FIGS. 1B and 1C).

The embodiment according to FIG. 1B is a flowfield that has a varying porosity in the direction normal to the polymer membrane, but has a substantially uniform porosity in planes parallel to the polymer membrane. According to this embodiment, the portion of the flowfield adjacent to the separator/bipolar plate has a higher porosity while the portion of the spacer adjacent to the membrane has a lower porosity. Furthermore, the porosity interior of the flowfield varies in a monotonic fashion in the direction normal to the membrane. Many structures deriving from this embodiment can be conceived, including flowfields with porosity gradients in the direction parallel to the membrane, spacers with gradients in both directions, spacers with non-monotonic porosity characteristics in a given direction, or others.

In some embodiments, the portion of the spacer having a higher porosity is adjacent to the separator plate to facilitate fluid flow. Meanwhile, the portion of the spacer having a lower porosity is adjacent to the membrane to facilitate electrode preparation, to mitigate risk of mechanical damage to the membrane, to provide more uniform mechanical loading under cell compression, and/or to improve water and thermal management inside the cell.

According to an embodiment illustrated in FIG. 1C, a flowfield may contain discrete subcomponents. The layers 1, 2, 3 and 4 in FIG. 1C each are chosen from expanded metal, wire mesh, metal foam, graphite foam, or planar or non-planar formed perforated metal sheets. The layers may be chemically, mechanically, or metallurgically joined to one another, or simply placed into contact by compression. Many structures deriving from this embodiment can be conceived, including composites of individual spacers placed side-by-side in a given layer, a layer consisting of discrete pellets, beads, rings, or other shapes, layering of individual pieces in a brickwork/staggered fashion, among others.

The flowfield according to FIG. 1a also contains a catalyst support layer, made from carbon or other electrically conductive material, and thereby forms a consolidated flowfield/electrode. The support layer allows gas diffusion into the electrode. It also serves as a buffer layer to mitigate corrosion of the metal flowfield spacer and further distributes mechanical stresses on the membrane to reduce propensity for damage under compression. The support layer can be treated to become hydrophobic either via a chemical coating, e.g., using polytetrafluoroethylene, or via surface and/or geometrical modifications that affect absorption energy. The hydrophobicity of the support layer influences water evacuation and maintenance of function. It also provides a high surface area substrate to support the electrode catalyst. The support layer can be formed by applying materials directly onto the surface of the open flowfield. It may also be made separately and bonded to the surface of the open flowfield.

FIG. 2 illustrates another embodiment in which the surface region of the flowfield in contact with the membrane has been made more dense and its surface smoother, e.g., having a lower surface roughness. A smooth contact surface reduces the possibility of damage to the membrane. The electrode catalyst is directly applied to this smooth surface. The smooth surface can be made, for example, through calendering in a pinch roller with a hard metal roller on one side and a soft felt or paper roller on the other. The side in contact with the hard metal roller will be compressed and made smoother than the side in contact with the soft felt or paper roller. Calendering process steps and parameters can be selected to achieve design specifications, including overall thickness of the flowfield, thickness of local layer, roughness of the flowfield, and tolerances of the flowfield.

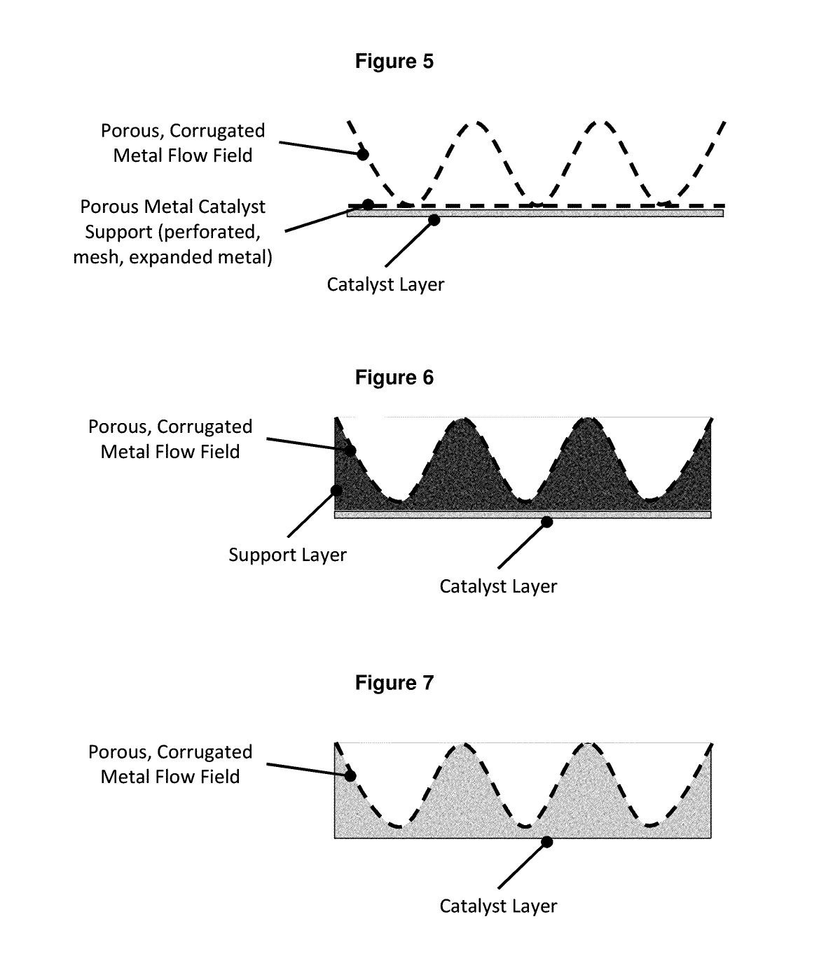

FIG. 3 illustrates an embodiment in which the electrode catalyst is directly applied to the metal flowfield. In this embodiment, no support layer is present. Special surface treatments of the metal may be required to facilitate physico-chemical bonding and/or stabilization of the catalyst, including, for example, chemical or plasma-based etching, surface layer doping or impregnation, mechanical roughening to increase surface area, or oxidation.

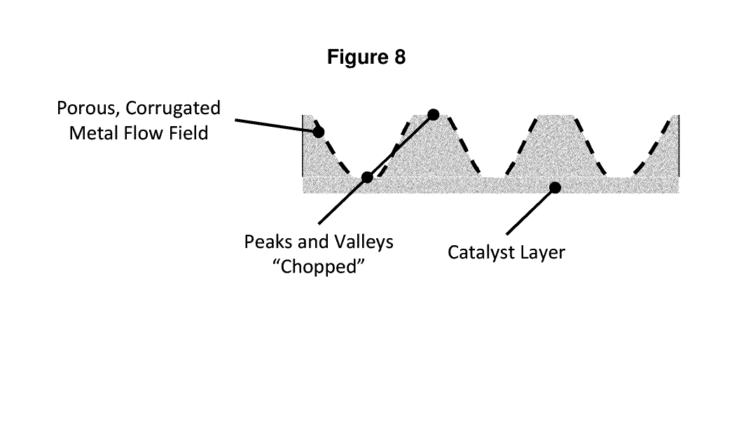

FIG. 4 depicts another embodiment in which the flowfield comprises a corrugated porous metal flowfield. The flowfield can be made from a perforated metal sheet, corrugated to form “peaks” and “valleys.” The valleys of the flowfield are in contact with a relatively flat, porous metal sheet. The metal sheet can be perforated metal, metal mesh, metal screen, expanded metal foil, metal felt, etc. Onto this relatively flat metal sheet a layer of catalyst support is applied. The electrode catalyst is then applied onto the catalyst support. Alternatively, as shown in FIG. 5, the catalyst support layer can be omitted. The electrode catalyst is directly applied onto the porous metal sheet.

In another embodiment depicted in FIG. 6, there is no flat porous metal sheet. The catalyst support layer is applied onto the corrugated metal sheet. Alternatively, catalyst can be applied directly onto the corrugated metal sheet as shown in FIG. 7. To reduce catalyst volume on the surface of the corrugated metal sheet that is not accessible to the reactants, the “peaks and valleys” of the corrugated metal sheet may be flattened as shown in FIG. 8. Another benefit of using the corrugated metal sheet without or with reduced “peaks and valleys” is that its contact surface area with adjacent fuel cell components increases, which reduces the internal electrical resistant of the fuel cell.

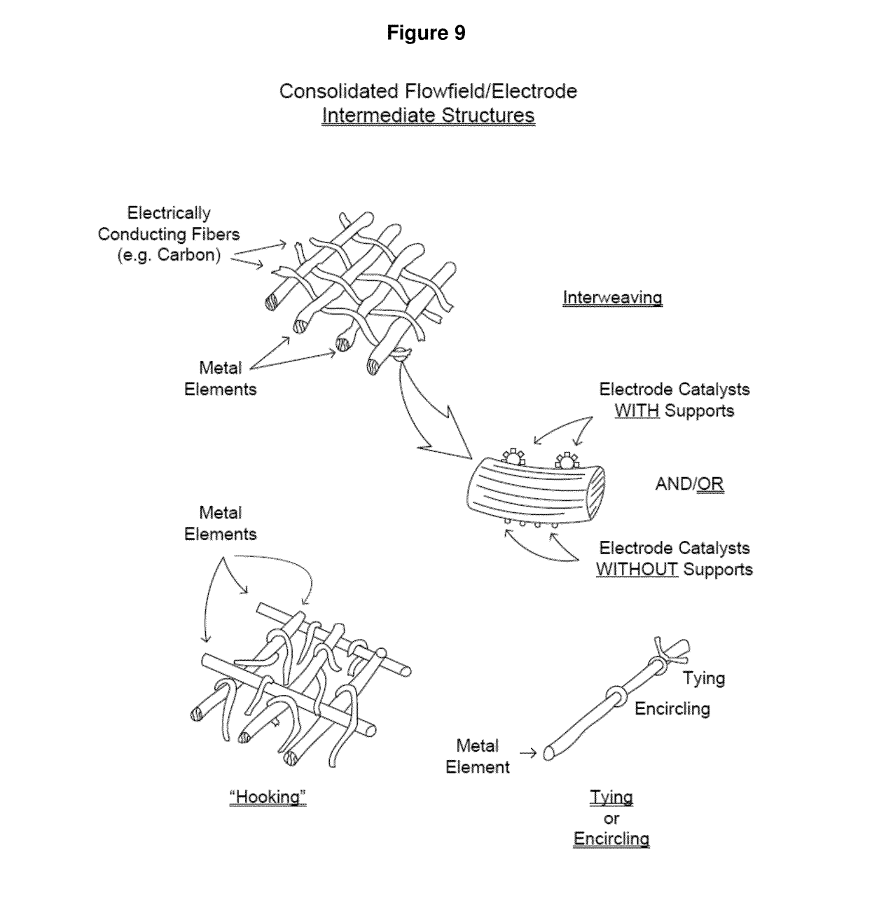

A further embodiment of this disclosure is directed to an electrode catalyst, with or without a support, which is physico-chemically bonded to an electrically-conducting but non-metallic intermediate structure, e.g. a carbon fiber. The metallic intermediate structure is disclosed above. To establish electrical connectivity between the spacer and the electrode, the intermediate structure and the spacer are mechanically connected, e.g., by interweaving (for example, composite metal fiber/carbon fiber cloth), “hooking” via co-penetration subsequent to application of compressive force (velcro-like), tying, or encircling. FIGS. 9A, 9B, and 9C depict these examples.

It will be apparent to those skilled in the art that various modifications and variations can be made without departing from the spirit of the invention. The present invention covers all such modifications and variations, provided they come within the scope of the claims and their equivalents.

1-20. (canceled)

21. A fuel cell comprising:
a polymer membrane;
a porous planar structure adjacent the polymer membrane, the porous planar structure having a first surface and a second surface, comprising:
at least one corrugated metal sheet with perforations, the at least one corrugated metal sheet defines a plurality of voids; and
a carbon-based catalyst support interposed between the porous planar structure and the polymer membrane, the catalyst support having one or more carbon filaments with an electrode catalyst deposited thereon;
wherein the catalyst support is configured to fill at least a portion of the plurality of voids defined by the first surface of the corrugated metal sheet.

22. The fuel cell of claim 21, wherein the one or more carbon filaments mechanically attach to one or more elements of the porous planar structure at the first surface.

23. The fuel cell of claim 22, wherein the one or more carbon filaments mechanically attach to one or more elements of the porous planar structure at the first surface by at least one of hooking, tying, and encircling.

24. The fuel cell of claim 21, wherein the porous planar structure further comprises a metal foam layer.

25. The fuel cell of claim 21, wherein the porous planar structure has a porosity that varies in a direction perpendicular to a planar direction of the porous structure.

26. The fuel cell of claim 21, wherein the porous planar structure has a porosity that is substantially uniform in the planes parallel to the planar direction of the porous planar structure.

27. The fuel cell of claim 21, wherein the corrugated metal sheet includes larger perforations at peaks and valleys of the corrugated metal sheet.

28. The fuel cell of claim 21, wherein the porous planar structure further comprises a wire mesh layer.

29. A fuel cell comprising:
a polymer membrane;
a porous planar structure adjacent the polymer membrane forming an open flowfield having a first surface and a second surface, comprising:
a plurality of layers of discrete subcomponents, at least two layers are chosen from a porous metal foam, a metal wire mesh, a wire mesh comprising metal wires and a non-metal component, a metal screen, a metal felt, an expanded metal sheet, a corrugated metal sheet with perforations, and a corrugated metal sheet without perforations;
wherein at least one layer includes a plurality of spacers placed side-by-side between at least two of the layers; and
a carbon-based catalyst support interposed between the porous planar structure and the polymer membrane, the catalyst support having one or more carbon filaments with an electrode catalyst deposited thereon.

30. The fuel cell of claim 29, wherein the one or more carbon filaments mechanically attach to one or more elements of the porous planar structure at the first surface.

31. The fuel cell of claim 30, wherein the one or more carbon filaments mechanically attach to one or more elements of the porous planar structure at the first surface by at least one of hooking, tying, and encircling.

32. The fuel cell of claim 29, wherein at least one layer is a metal foam layer.

33. The fuel cell of claim 32, wherein the metal foam layer has a porosity that varies in a direction perpendicular to a planar direction of the porous structure.

34. The fuel cell of claim 32, wherein the metal foam layer has a porosity that is substantially uniform in the planes parallel to the planar direction of the porous planar structure.

35. A fuel cell comprising:
a polymer membrane;
a porous planar structure adjacent the polymer membrane, the porous planar structure having a first surface and a second surface, comprising:
at least one corrugated metal sheet with perforations, the at least one corrugated metal sheet defines a plurality of voids;
an electrode catalyst layer interposed between the first surface of the porous planar structure and the polymer membrane;
wherein the electrode catalyst layer is configured to fill at least a portion of the plurality of voids defined by the first surface of the corrugated metal sheet.

36. The fuel cell of claim 35, wherein the porous planar structure further comprises a metal foam layer.

37. The fuel cell of claim 36, wherein the porous planar structure has a porosity that varies in a direction perpendicular to a planar direction of the porous structure.

38. The fuel cell of claim 36, wherein the porous planar structure has a porosity that is substantially uniform in the planes parallel to the planar direction of the porous planar structure.

39. The fuel cell of claim 35, wherein the corrugated metal sheet includes larger perforations at peaks and valleys of the corrugated metal sheet.

40. The fuel cell of claim 35, wherein the porous planar structure further comprises a wire mesh layer.
